(19) United States
(12) Patent Application Publication
(10) Pub. No.: US 2008/0168142 A1
(43) Pub. Date: Jul. 10, 2008

(54) METHOD FOR INTELLIGENT VERIFICATION OF ELECTRONIC MAIL MESSAGE ADDRESSES

(75) Inventor: William H. Chung, Cortlandt Manor, NY (US)

Correspondence Address: CANTOR COLBURN LLP-IBM YORKTOWN, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/620,848

(22) Filed: Jan. 8, 2007

(51) Int. Cl. G06F 15/16

(52) U.S. Cl. 709/206

(57) ABSTRACT

A method for the intelligent verification of recipient electronic message addresses with active alerts for incorrect and ambiguous recipient electronic message addresses provided to a sender prior to the dissemination of an electronic message, wherein the method includes adding the recipient electronic message addresses by the sender to the electronic message; initiating the disbursement of the electronic message by the sender; determining incorrect and ambiguous recipient electronic message addresses by searching the records of previous electronic communications involving the sender, and matching the recipient electronic message addresses added by the sender to addresses found in the records; notifying the sender based on the determination of matching recipient electronic message addresses, and establishing a subset thereof; recommending to the sender which recipient electronic message address to use from the subset; and disbursing the electronic message with the recommended recipient electronic message addresses.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates generally to electronic mail messaging, and more specifically to providing a method, article, and system for the intelligent verification of recipient electronic mail addresses with active alerts for incorrect or ambiguous recipient electronic mail addresses provided to the sender prior to the dissemination of the electronic message.

2. Description of the Related Art

Electronic mail has become a central feature of modern life and users have come to expect to receive electronic mail messages at any time and in virtually any place. For example, during the course of one day of travel, a user may receive electronic mail messages at a home desktop computer in the early morning, an office desktop computer in midmorning, via a cell phone or personal digital assistant in a taxi on the way to the airport, on a laptop computer via a wireless local area network while waiting in the airport lounge, via an in-flight telephone on the airplane, and in a hotel room via a high-speed Internet connection provided by the hotel at the end of the day.

The widespread proliferation and availability of electronic messaging has provided an efficient method to communicate information. In fact electronic messaging with its near instantaneous delivery from sender to receiver has made it the preferred method of personnel and business communication where hardcopy signatures are not required. In addition the ease of use and minimal cost of distribution has led to mass email to large distribution lists. However, the widespread use of electronic messaging has led to the problem of more users than easily distinguished unique personnel electronic mail addresses. Electronic messages often get sent to the wrong recipient because electronic message addresses are sometimes not unique, especially when a person's name is used as an address, or if only a partial address is entered. For example, if there are two different people with the name of John Doe at a company, the electronic message may get sent to the other John Doe because senders address the electronic message to John Doe or Doe instead of spelling out their full, unique electronic message address JohnSDoe@xyz.com. Even if a sender does use an address instead of a name, there may two (or more) different addresses with the userid JohnSDoe at XYZ. So simply sending to the address JohnSDoe can also result in problems because such a partial address is not unique.

One solution to this problem is to look up addresses in a directory (i.e. an address book) and then warn the user if an address is ambiguous, because the address can be mapped to more than one directory entry. Unfortunately, such a solution has drawbacks because the warning can easily be bypassed. In addition, a directory is usually quite large and stored remotely across a network making it impossible to access when not connected to a network

### SUMMARY OF THE INVENTION

A method for the intelligent verification of recipient electronic message addresses with active alerts for incorrect and ambiguous recipient electronic message addresses provided to a sender prior to the dissemination of an electronic message. The method includes: adding the recipient electronic message addresses by the sender to the electronic message; initiating the disbursement of the electronic message by the sender; determining incorrect and ambiguous recipient electronic message addresses by searching the records of previous electronic communications involving the sender, and matching the recipient electronic message addresses added by the sender to addresses found in the records; notifying the sender based on said determining of matching recipient electronic message addresses, and establishing a subset thereof; recommending to the sender which recipient electronic message address to use from the subset; and disbursing the electronic message with the recommended recipient electronic message address.

An article comprising one or more machine-readable storage media containing instructions that when executed enable a processor to perform intelligent verification of recipient electronic message addresses with active alerts for incorrect and ambiguous recipient electronic message addresses prior to the dissemination of an electronic message; wherein the instructions comprise algorithms for implementing the intelligent verification of recipient electronic message addresses; and wherein the algorithm further includes: determining incorrect and ambiguous recipient electronic message addresses by searching the records of previous electronic communications involving a sender, and matching the recipient electronic message addresses added by the sender to addresses found in the records; notifying the sender based on said determining of matching recipient electronic message addresses, and establishing a subset thereof; recommending to the sender which recipient electronic message address to use from the subset; and disbursing the electronic message with the recommended recipient electronic message address.

A system for distributing electronic messages with intelligent verification of recipient electronic message addresses with active alerts for incorrect and ambiguous recipient electronic message addresses prior to the dissemination of an electronic message; wherein the system comprises computing devices and a network; wherein the computing devices further comprise at least one of the following: computer servers; mainframe computers; desktop computers; and mobile computing devices; and wherein at least one of the computing devices is configured to execute electronic software that manages the electronic message exchange with intelligent verification of recipient electronic message addresses; and wherein the electronic software is resident on a storage medium in signal communication with at least one of the computing devices; and wherein at least one of the computing devices is capable of signal communication with the network; and wherein the network further comprises at least one of the following: local area network (LAN); wide area network (WAN); a global network; the internet; an intranet; wireless networks; and cellular networks; and wherein the electronic software determines incorrect and ambiguous recipient electronic message addresses by searching the records of previous electronic communications involving a sender, and matching the recipient electronic message addresses added by the sender to addresses found in the records; notifies the sender based on the determining of matching recipient electronic message addresses, and establishing a subset thereof; recommends to the sender which recipient electronic message address to use from the subset; and disburses the electronic message with the recommended recipient electronic message address.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### Technical Effects

As a result of the summarized invention, a solution is technically achieved in which an algorithm is employed for the intelligent verification of recipient electronic mail addresses with active alerts for incorrect or ambiguous recipient electronic mail addresses provided to the sender prior to the dissemination of the electronic message.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates a system for practicing one or more embodiments of the present invention.

FIG. 2 is a flow diagram illustrating a method for implementing verification of electronic message addresses according to an embodiment of the present invention.

The detailed description explains the preferred embodiments of the invention, together with advantages and features, by way of example with reference to the drawings.

### DETAILED DESCRIPTION OF SPECIFIC EMBODIMENTS

Embodiments of the present invention provide a method, article, and system for the intelligent verification of recipient electronic mail addresses with active alerts for incorrect or ambiguous recipient electronic mail addresses provided to the sender prior to the dissemination of the electronic message.

Embodiments of the invention search records of previous correspondences to determine the likelihood of an address being correct. An address book represents one form of record of previous correspondence. An address in an address book is likely to be someone the user has exchanged messages with previously. Another record of previous correspondence can be found in the list of received messages (inbox) and sent messages (outbox). Embodiments of the present invention search the user's inbox and outbox to generate additional records of previous correspondences. The search is carried out with a scoring algorithm that is used to weight the probability of a particular address being correct; instead of using simple text matching. The advantage of the present invention is that it more accurately recognizes ambiguous, misspelled, and/or inaccurate addresses because it verifies addresses against a richer set of sources. Additional advantages of embodiments of the present invention are: a more intelligent search mechanism, which goes beyond simple text matching by incorporating a scoring algorithm to more accurately judge whether or not an address is truly ambiguous, thus reducing false positive alerts which could be annoying for the sender; address verification can be performed without requiring access to a network or an address book (directory) stored across a network.

An embodiment of the present invention can be implemented as follows. Every time a user hits the send key or invokes some other command to send an electronic message, several lists are searched for each address in the electronic message. The lists are generated beforehand from all received messages, and from all sent messages. Each time a match is found, the match can be assigned a score based on factors such as whether or not an address is present in the senders personal address book. A graphical user interface (GUI) can present the user with the search results based on the address weightings, if the searches point to an ambiguous address. Based on the results of the searches, the user can decide if they have selected the correct address for the intended receiver.

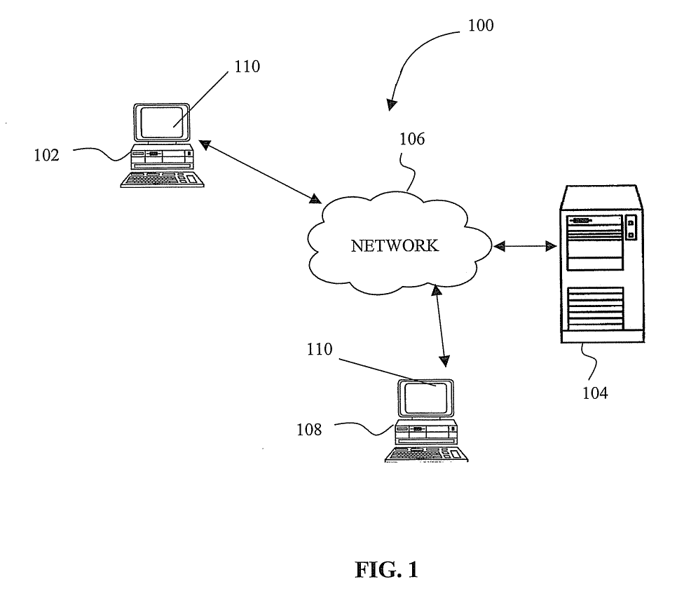

FIG. 1 is a block diagram of an exemplary system 100 for implementing the electronic message address verification of an embodiment of the present invention and graphically illustrates how those blocks interact in operation. The system includes one or more electronic message sending workstations 102 coupled to a server system 104 via a network 106. Each electronic message sending workstation 102 may be implemented using a general-purpose computer executing a computer program for carrying out the processes described herein. The computer program may be resident on a storage medium local to the sending workstation 102, or maybe stored on the server system 104. The server system 104 may belong to a public electronic message service. The network 106 may be any type of known network including a local area network (LAN), wide area network (WAN), global network (e.g., Internet), intranet, etc. The electronic message sending workstations 102 may be coupled to the server system 104 through multiple networks (e.g., intranet and Internet) so that not all electronic message sending workstations 102 are coupled to the server system 104 via the same network. The sending workstations 102 and the server system 104 may be connected to the network 106 in a wireless fashion, and network 106 may be a wireless network. In a preferred embodiment, the network 106 is a LAN and each sending workstation 102 executes a user interface application (e.g., web browser) to contact the server system 104 through the network 106. Alternatively, a sending workstation 102 may be implemented using a device programmed primarily for accessing network 106 such as a remote client. The sending workstation 102 may be implemented by using a general-purpose computer intermittently connected to a network, by storing and sending electronic messages in batches. A network 106 may or may not be present when the address verification is being performed.

In addition to sending workstations 102, the system includes one or more electronic message receiving workstations 108 coupled to server system 104. Each receiving workstation 108 may be implemented using a general-purpose computer executing a computer program for carrying out the processes described herein. The computer program may be resident on a storage medium local to the receiving workstation 108, or maybe stored on the server system 104. The sending workstations 102 and the receiving workstations 108 may access the server system 104 over the same or different networks (e.g., an intranet and Internet). In one embodiment, the receiver workstations 108 execute a user interface application (e.g., web browser) to contact the server system 104 through the network 106. Alternatively, the receiver workstations 108 may be implemented using a device programmed primarily for accessing network 106 such as a remote client. It should also be noted that both the electronic message sending workstations 102 and receiving workstations 108 could change roles and act as receiver or sender work station, respectively.

The electronic message program provides functionality to the user with the same options for sending electronic messages as in prior art programs, but with the additional ability to allow the user to have increased confidence in the addresses of the intended recipient(s).

The program generates and displays, by well-known software methods, a graphical user interface to the user of a computer on which the program is running. An example of such a user interface is represented in FIG. 1 as the screens 110. In FIG. 1, graphical user interface (GUI), as displayed on the screen 110 of sending workstation 102, presents the user with a ranking of probable recipients based on a weighting system of names obtained from a search of records of previous electronic communications in the senders address book, inbox and outbox. The GUI allows the user to select the recipient with the highest probability of being the correct target recipient in instances where there is an ambiguity of intended receivers. In addition, certain options and/or shortcuts to options are provided to the user by clicking on representative icons with a mouse or other similar selecting or pointing device.

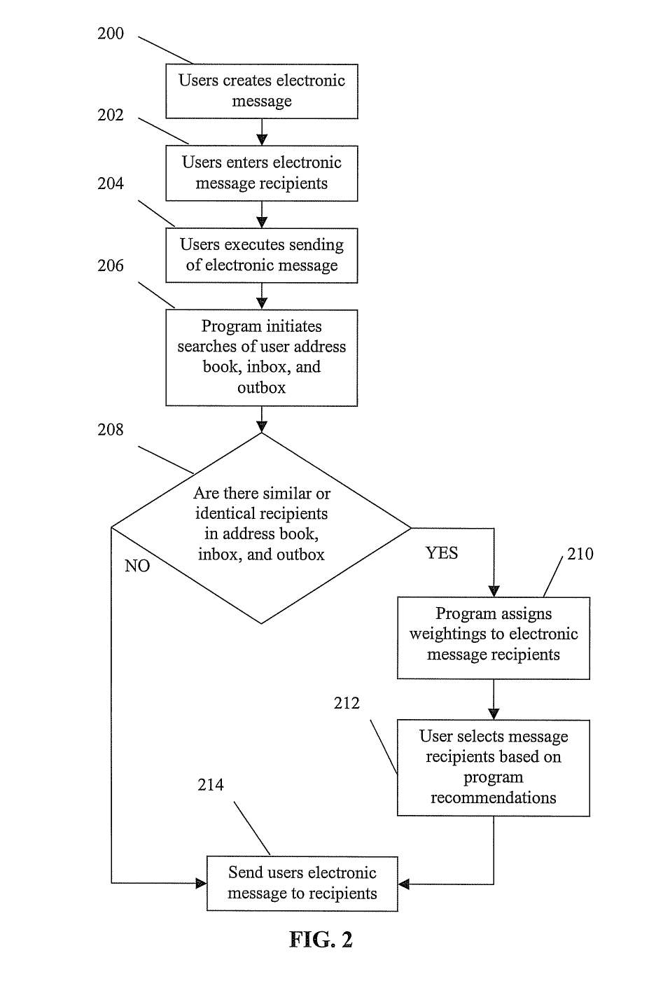

FIG. 2 is a flow diagram illustrating a process for generating an electronic message (for example e-mail) with intelligent verification of recipient electronic mail addresses in accordance with an embodiment of the present invention. As shown in the figure, in step 200, a sender composes an electronic message in a customary manner. At step 202, the sender enters the addresses of the proposed intended recipients. The sender initiates the distribution of the electronic message 204. The program begins a search of the senders address book, inbox, and outbox 206. If the program does not find similar or identical recipients (208) the electronic message is sent to the recipients 214. However, if the program's searches determine there are similar or identical recipients (208), the program assigns weightings to the electronic message recipients 210. The user selects the message recipient addresses based on the program's recommendations 212, and the electronic message is sent to the recipient(s) 214.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for the intelligent verification of recipient electronic message addresses with active alerts for incorrect and ambiguous recipient electronic message addresses provided to a sender prior to the dissemination of an electronic message, wherein the method comprises:
adding the recipient electronic message addresses by the sender to the electronic message;
initiating the disbursement of the electronic message by the sender;
determining incorrect and ambiguous recipient electronic message addresses by searching the records of previous electronic communications involving the sender, and matching the recipient electronic message addresses added by the sender to addresses found in the records;
notifying the sender based on said determining of matching recipient electronic message addresses, and establishing a subset thereof;
recommending to the sender which recipient electronic message address to use from the subset; and
disbursing the electronic message with the recommended recipient electronic message address.

2. The method of claim 1, wherein the records of previous electronic communications comprises:
an inbox;
an outbox; and
address book of the sender.

3. The method of claim 1, wherein:
said notifying is facilitated by a graphical user interface.

4. The method of claim 1, wherein:
said notifying is facilitated by audible sounds.

5. The method of claim 1, wherein:
said recommending to the sender which recipient electronic message address to use from the subset is based on weighting the recipient electronic message addresses in the subset, and recommending the recipient electronic message with the highest weighting to the sender.

6. The method of claim 5 wherein said weighting is based on the frequency of use of the recipient electronic message address.

7. An article comprising one or more machine-readable storage media containing instructions that when executed enable a processor to perform intelligent verification of recipient electronic message addresses with active alerts for incorrect and ambiguous recipient electronic message addresses prior to the dissemination of an electronic message;
wherein the instructions comprise algorithms for implementing the intelligent verification of recipient electronic message addresses; and
wherein the algorithm further comprises:
determining incorrect and ambiguous recipient electronic message addresses by searching the records of previous electronic communications involving a sender, and matching the recipient electronic message addresses added by the sender to addresses found in the records;
notifying the sender based on said determining of matching recipient electronic message addresses, and establishing a subset thereof;
recommending to the sender which recipient electronic message address to use from the subset; and
disbursing the electronic message with the recommended recipient electronic message address.

8. The article of claim 7, wherein the records of previous electronic communications comprises:
an inbox;
an outbox; and
address book of the sender.

9. The article of claim 7, wherein the notifying is facilitated by a graphical user interface.

10. The article of claim 7, wherein the notifying is facilitated by audible sounds.

11. The article of claim 7, wherein the recommending to the sender which recipient electronic message address to use from the subset is based on weighting the recipient electronic message addresses in the subset, and recommending the recipient electronic message with the highest weighting to the sender.

12. The article of claim 7 wherein said weighting is based on the frequency of use of the recipient electronic message address.

13. A system for distributing electronic messages with intelligent verification of recipient electronic message addresses with active alerts for incorrect and ambiguous recipient electronic message addresses prior to the dissemination of an electronic message;
wherein the system comprises computing devices and a network;
wherein the computing devices further comprise at least one of the following:
computer servers;
mainframe computers;
desktop computers; and
mobile computing devices; and
wherein at least one of the computing devices is configured to execute electronic software that manages the electronic message exchange with intelligent verification of recipient electronic message addresses; and
wherein the electronic software is resident on a storage medium in signal communication with at least one of the computing devices; and
wherein at least one of the computing devices is capable of signal communication with the network; and
wherein the network further comprises at least one of the following:
local area network (LAN);
wide area network (WAN);
a global network;
the Internet;
an intranet;
wireless networks; and
cellular networks; and
wherein the electronic software determines incorrect and ambiguous recipient electronic message addresses by searching the records of previous electronic communications involving a sender, and matching the recipient electronic message addresses added by the sender to addresses found in the records;
notifies the sender based on said determining of matching recipient electronic message addresses, and establishing a subset thereof;
recommends to the sender which recipient electronic message address to use from the subset; and
disburses the electronic message with the recommended recipient electronic message address.

14. The system of claim 13, wherein the records of previous electronic communications comprises:
an inbox;
an outbox; and
address book of the sender.

15. The system of claim 13, wherein:
the records of previous electronic communications are stored on the computing device, and verification of recipient electronic message addresses is independent of the network.

16. The system of claim 13, wherein:
the records of previous electronic communications are stored on the network, and verification of recipient electronic message addresses is carried out with the network.

17. The system of claim 13, wherein:
the notifying is facilitated by a graphical user interface.

18. The system of claim 13, wherein:
the notifying is facilitated by audible sounds.

19. The system of claim 13, wherein:
the recommending to the sender which recipient electronic message address to use from the subset is based on weighting the recipient electronic message addresses in the subset, and recommending the recipient electronic message with the highest weighting to the sender.

20. The system of claim 13, wherein:
the weighting is based on the frequency of use of the recipient electronic message address.
